(19) United States
(12) Patent Application Publication
(10) Pub. No.: US 2012/0144878 A1
(43) Pub. Date: Jun. 14, 2012

(54) DEVICE FOR DISPENSING AN ADDITIVE IN AN APPLIANCE

(76) Inventors: Alaknanda Acharya, Hyderabad (IN); David Dunn, Smithfield, KY (US); Mohan Ponnaganti, Andhra Pradesh (IN)

(21) Appl. No.: 12/965,950

(22) Filed: Dec. 13, 2010

(51) Int. Cl. D06F 35/00; B67D 7/16

(52) U.S. Cl. 68/17 R; 222/71

(57) ABSTRACT

Embodiments of an appliance are described that are configured for bulk handling and dispensing of an additive. The appliance includes a dispensing device that has in one example a bulk compartment and a dispense compartment. The dispensing device also includes a flow control device such as a valve that controls gravity-flow communication of the additive between the bulk compartment and the dispense compartment. In one embodiment, a fluid conduit carries a washing fluid such as water to the dispense compartment, thereby flushing the additive from the dispense compartment and into a wash tub of the appliance.

### BACKGROUND OF THE INVENTION

The subject matter disclosed herein relates generally to appliances, and more particularly, to dispensing devices that are configured to retain and dispense an additive to areas of the appliance.

Appliances such as washing machines come in various configurations including top-load and front-load configurations that define by orientation the way in which an end user loads articles for cleaning. Regardless of the configuration, however, these washing machines generally include a cabinet in which is disposed a wash tub for containing wash and rinse water. A wash basket that receives the articles is rotatably mounted within the wash tub, and in certain configurations an agitating element is rotatably positioned within the wash basket. One or more of the wash basket and the agitating element is coupled to a drive assembly and a brake assembly, both of which are positioned with respect to the wash tub and configured to rotate and control the agitation of the wash basket. A pump assembly is also included to drain soiled water to a drain system.

Washing machines also include a dispenser assembly, which is located and often affixed to an inner portion of the cabinet. The dispenser assembly is compatible with additives for cleaning the articles, including detergents and bleach, both of which come in liquid and powder forms. The dispenser assembly includes, for example, a reservoir in which the additive is held before it is dispensed into the wash tub. In washing machines wherein the reservoir is sized and configured for a single-use or single-load configuration, access to the reservoir is provided so the end user can fill the reservoir with the additive for each separate load of articles that is washed in the washing machine.

To eliminate the need for frequent replenishing of the reservoir by the end user, some washing machines are configured so the dispenser assembly holds enough additive for several loads of articles. Often referred to as “bulk” dispensers, these dispenser assemblies typically use a pump that is coupled to the reservoir and that is activated to move the additive from the reservoir and to dispense the additive into the wash tub. However, pumps are prone to problems such as clogging and related flow-reducing defects because additives such as liquid and diluted powder-like detergents are of relatively high viscosity. These problems can reduce the effectiveness of the washing machine. Moreover, use of the pumps to move the additives uses energy and also adds cost and complexity to the overall design and construction of the washing machine.

There is a need, therefore, for a dispensing assembly that is configured as a bulk dispenser, but that does not require a pump to move the additive about the washing machine.

### BRIEF DESCRIPTION OF THE INVENTION

Embodiments of the appliances discussed below are configured with a dispensing device that provides the benefits of bulk dispensing, but without the potential problems and costs associated with the construction (e.g., the pumps) used in conventional bulk dispensing systems.

Further discussion of these concepts, briefly outlined above, is provided below in connection with one or more embodiments.

In one embodiment, a dispensing device for dispensing an additive in an appliance is described, the dispensing device comprising a first compartment, a second compartment in gravity-flow communication with the first compartment, and a flow control device through which can flow the additive from the first compartment to the second compartment. In one example, the flow control device is configured to regulate a pre-determined amount of the additive that flows by gravity out of the second compartment.

In another embodiment, an appliance is described that comprises a wash tub, a dispensing device in fluid communication with the wash tub, and a fluid inlet coupled to the dispensing device. In one example, the dispensing device has a dispensing condition in which an additive flows by gravity from a first location to a second location at which the additive is exposed to a washing fluid from the fluid inlet. The dispensing device is also configured to regulate a pre-determined amount of the additive that is dispensed from the second location.

### BRIEF DESCRIPTION OF THE DRAWINGS

Reference is now made briefly to the accompanying drawings, in which:

FIG. 1 is a schematic diagram of an exemplary embodiment of an appliance.

FIG. 2 is a schematic diagram of another exemplary embodiment of an appliance.

FIG. 3 is a schematic diagram of yet another exemplary embodiment of an appliance.

FIG. 4 is a schematic diagram of still yet another exemplary embodiment of an appliance.

FIG. 5 is a schematic diagram of an example of a control configuration for use with an appliance such as the appliances of FIGS. 1-4.

FIG. 6 is a perspective view of a washing machine embodying the concepts of the appliances of the present disclosure, such as the appliances of FIGS. 1-4.

FIG. 7 is an elevational, schematic view of the washing machine shown in FIG. 6.

Where applicable like reference characters designate identical or corresponding components and units throughout the several views, which are not to scale unless otherwise indicated.

### DETAILED DESCRIPTION OF THE INVENTION

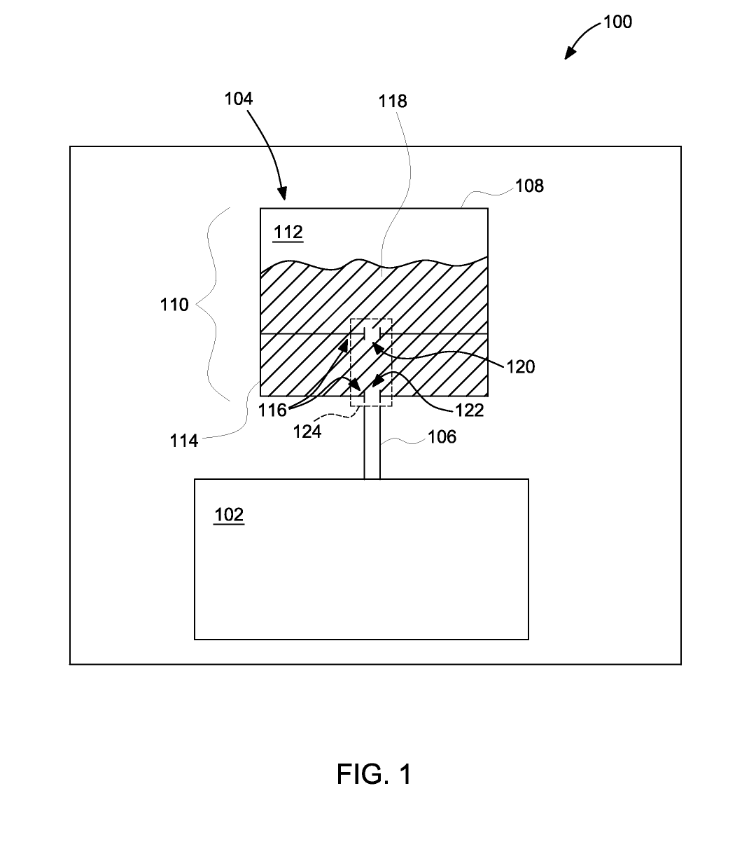

To further illustrate the concepts of this disclosure, attention is directed to FIG. 1, in which there is depicted a schematic diagram of an appliance 100. The appliance 100 includes a wash tub 102 and a dispensing device 104, which is coupled to the wash tub 102 by way of a fluid transport system 106 that comprises tubing, fittings, valves, and related implements used to carry a washing fluid (e.g., water) throughout the appliance 100. The dispensing device 104 includes a tank 108 constructed as a multi-compartment structure 110 with a bulk or first compartment 112 and a dispense or second compartment 114. Openings 116 are provided in the dispense compartment 114 so as to promote communication of an additive 118 (e.g., liquid detergent), and in the present example there is provided an upper opening 120 and a lower opening 122 (collectively, “openings”) that facilitate communication of the additive 118 into and out of the dispense compartment 114.

In one embodiment, the upper opening 120 and the lower opening 122 are coupled to a flow control device 124. The flow control device 124 has one or more configurations that are useful to control and/or meter the movement of the additive 118. This movement is from one or more locations and/or among the compartments of the multi-compartment structure 110. By way of example, but not limitation, the flow control device 124 can have a first position that permits the additive 118 to move from a first location in the bulk compartment 112 to a second location in the dispense compartment 114 via the upper opening 120. The flow control device 124 can also have a second position that allows the additive to move out of the dispense compartment 114 via the lower opening 122.

The flow control device 124 can comprise one or more valves and/or flow regulators, which in one example are generally coupled to the upper opening 120 and the lower opening 122. These valves can be compatible with various constitutions of the additive 118 such as liquids and granular materials. Actuation of the valves changes the configuration of the flow control device 124 such as between the first position and the second position discussed above. Opening the valves can permit gravity-flow communication of the additive 118 as between one or more of the bulk compartment 112, the dispense compartment 114, and the fluid transport system 106. Likewise closing the valves can substantially prevent gravity-flow communication of the additive 118 as between one or more of the bulk compartment 112, the dispense compartment 114, and the fluid transport system 106.

Examples of the flow control device 124 comprise solenoid valves or similar electromechanical valve devices that are useful to effectuate these various configurations, e.g., the first position and the second position, as well as other operating conditions for the appliance 100 described below. While multiple valves can be used, such as one each for the upper opening 220 and the lower opening 222, in one example the flow control device 224 incorporates a single valve (or double-acting valve). This single valve is configured to interface with each of the upper opening 220 and the lower opening 222 as contemplated herein.

In one embodiment, and as depicted in FIG. 1, the flow control device 124 is incorporated into the construction of the tank 108, which can include various materials such as plastics and/or other materials consistent with the cost, size, shape, and similar constructive restrictions of consumer appliances. Although the tank 108 is illustrated in FIG. 1 as a rectangular box-like container, the container may be embodied in any shape and size that is receivable inside of the appliance 100. The container may be flexible, rigid, expandable, or collapsible. The container can be a single unitary structure, wherein the various compartments (e.g., the bulk compartment 112 and the dispense compartment 114) of the multi-compartment structure 110 are formed monolithically with one another. Materials and manufacturing techniques can also be used so that in other constructions, the tank 108 is formed as separate pieces that are assembled together with fasteners such as adhesives to secure together the various pieces and components.

Dimensions of the tank 108, and in particular, the bulk compartment 112 are suited to accommodate or contain an amount of the additive 118 such as liquid detergent. The volume or capacity can be selected, for example, so as to provide sufficient amount of the additive 118 for several days, weeks, and even months without the need to frequently add detergent and/or other laundry additives. Comparatively, the dispense compartment 114 is of smaller dimensions than the bulk compartment 112. In one example, these dimensions are selected so as to define an amount of the additive 118 in the dispense compartment 114 that is suitable for, e.g., a single load of laundry that is washed in the wash tub 102.

The tank 108 is compatible with a variety of treating chemistries for use as the additive 118. The treating chemistry may be any type of aid for treating fabric. Examples may include, but are not limited to, washing aids, such as detergents and oxidizers (e.g., bleach), and additives such as fabric softeners, sanitizers, de-wrinklers, and chemicals for imparting desired properties to the fabric. These properties include stain resistance, fragrance (e.g., perfumes), insect repellency, and ultra-violet (UV) protection.

When implemented in the appliance 100, configurations of the dispensing device 104 dispense the additive 118 to the wash tub 102 without the need for pumps or other means to transport the additive 118. In one embodiment, the tank 108 is configured with the dispense compartment 114 subjacent or below the bulk compartment 112. This configuration utilizes gravity as the motive force to facilitate gravity-flow communication of the additive 118 from the bulk compartment 112 to the dispense compartment 114 via the upper opening 120.

In this connection, features and configurations of the openings 116 (such as size, shape, and other dimensional and constructive features) may be included based on the properties (e.g., viscosity and/or granularity) of the preferred, desired, or target treating chemistry for use as the additive 118. These features may be universally implemented to accommodate all different types of treating chemistries. In other embodiments, the features may be particularly designed and implemented to accommodate individual ones of the treating chemistry, and in one construction the tank 108 (and the dispensing device 104 generally) can be configurable thereby permitting implementation of the dispensing device 104 with all different-types of treating chemistries. While not necessarily illustrated in the present disclosure, operative features of the openings 116 may require funnel-type features, variable-diameter orifices, and the like.

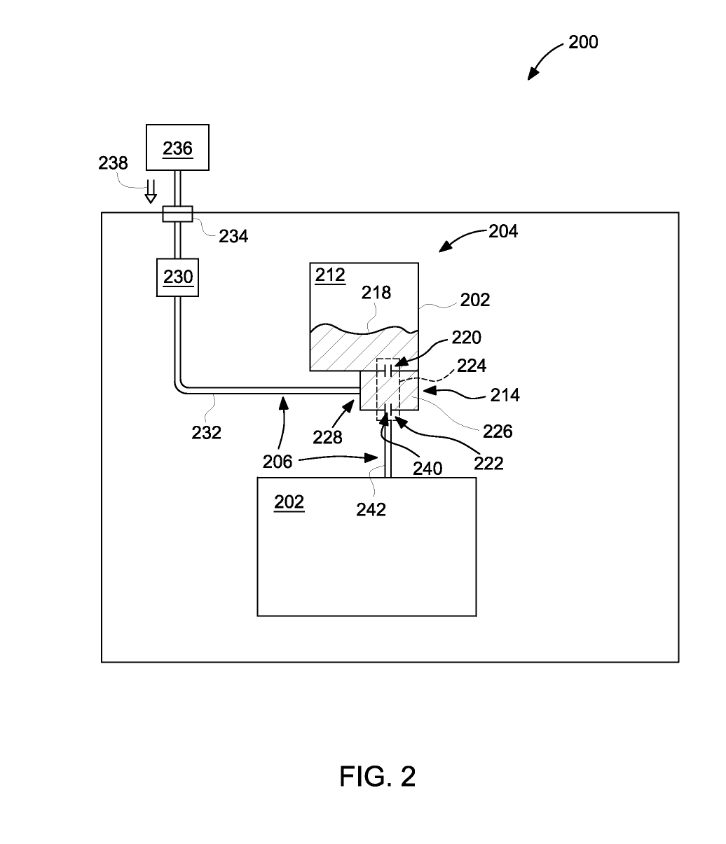

In one implementation, the tank 108 is coupled to a fluid inlet (not shown), which permits ingress of the washing fluid into the appliance 100. The washing fluid may flow from the fluid inlet, such as through the fluid transport system 106, and into the dispense compartment 114. Ingress of the washing fluid into the dispense compartment 114 dilutes the additive 118, forming in one example an additive/washing fluid mixture. In one embodiment, placing the flow control device 124 in its second position allows the mixture to flow into and about the appliance 100, with one example permitting the mixture to be dispensed into the wash tub 102. Additional details of this and other concepts are discussed below in connection with FIGS. 2-4.

Turning now to FIG. 2, there is depicted in schematic form another exemplary embodiment of an appliance 200. Like numerals are used to identify like components as between FIGS. 1 and 2, but the numerals are increased by 100 (e.g., 100 in FIG. 1 is 200 in FIG. 2). For example, the appliance 200 includes a wash tub 202, a dispensing device 204, and a fluid transport system 206. The dispensing device 204 includes a bulk or first compartment 212, a dispense or second compartment 214 with an upper opening 220 and a lower opening 222, and a flow control device 224. The dispense compartment 214 is configured with a metering chamber 226, through which is flushed an additive 218 to the wash tub 202.

In one embodiment, the metering chamber 226 has an inlet side 228, which is coupled to a washing fluid inlet valve 230 via an inlet conduit 232. The washing fluid inlet valve 230 is fluidly coupled to a fluid inlet 234, and in one construction the fluid inlet 234 is in fluid communication with a fluid supply 236 that supplies a washing fluid 238 such as water. Other configurations of the appliance 200 are also contemplated, however, wherein the washing fluid inlet valve 230 is located at the end of the inlet conduit 232 and proximate the inlet side 228. The metering chamber 226 also includes an outlet side 240, which in this example includes the lower opening 222, and which is in fluid communication with the wash tub 202 via an outlet conduit 242.

By way of example, in one implementation, the dispensing device 204 has a default condition wherein the flow control device 224 is configured to place the bulk compartment 212 in gravity-flow communication with the metering chamber 226. This default condition permits the additive 218 to fill the metering chamber 226 such as by way of gravity acting upon the additive 218 in the tank 208. In this default condition, the flow control device 224 also prevents the additive from exiting the metering chamber 226 such as through the outlet side 240. The dispensing device 204 also has a dispensing condition in which the flow control device 224 is configured so the additive 218 can flow by gravity out of the metering chamber 226 via the outlet side 240. In one example, in the dispensing condition, the flow control device 224 is configured to also prevent the flow of the additive 218 via the upper opening 220.

When implemented in, e.g., a washing machine, the additive 218 is flushed directly from the metering chamber 226 via the lower opening 222. In one example, the washing fluid 238 flows through the washing fluid inlet valve 230, to the inlet conduit 232, and into the inlet side 228 of the metering chamber 226. The washing fluid 238 mixes with the additive 218 to form the additive/washing fluid mixture. The mixture moves into the outlet conduit 242 and on towards the wash tub 202.

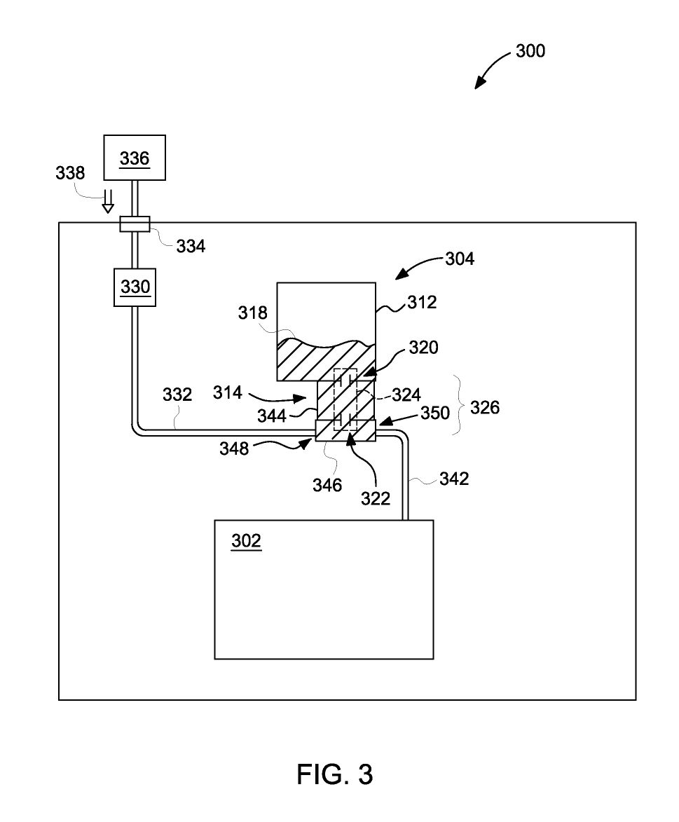

Referring next to FIG. 3, there is depicted in schematic form yet another exemplary embodiment of an appliance 300. Again like numerals are used to identify like components as between FIGS. 2 and 3, but the numerals are increased by 100 (e.g., 200 in FIG. 2 is 300 in FIG. 3). For example, it is shown that the appliance includes a wash tub 302 and a dispensing device 304 with a bulk compartment 312 and a dispense compartment 314, which has an upper opening 320 and a lower opening 322. The dispensing device 304 also includes a flow control device 324 and a metering chamber 326. The appliance 300 also includes a washing fluid inlet valve 330, an inlet conduit 332, a fluid inlet 334 that is coupled to a fluid supply 336, and an outlet conduit 342.

Particular to the present example of FIG. 3, the metering chamber 326 is further separated into a buffer chamber 344 and a collection chamber 346, or third compartment, which in one construction communicates with the buffer chamber 344 via the lower opening 322. The collection chamber 346 has an inlet side 348 and an outlet side 350. The inlet side 348 is coupled to the washing fluid inlet valve 330 via the inlet conduit 332, and the outlet side 350 is in fluid communication with the wash tub 302 via the outlet conduit 342.

Discussing the operation of the dispensing device 304, in the default condition the flow control device 324 is in its first position, which prevents the flow of the additive 318 from the buffer chamber 344 to the collection chamber 346. This configuration allows the buffer chamber 344 to fill with the additive 318 such as by gravity flow. When the dispensing condition is initiated, e.g., by a wash cycle, the flow control device 324 is changed to its second position, which permits flow of the additive from the buffer chamber 344 to the collection chamber 346.

In one implementation, the washing fluid inlet valve 330 is opened, thereby permitting the washing fluid 338 to enter the collection chamber 346. The ingress of the washing fluid 338 dilutes the additive 318 to form the additive/washing fluid mixture. This mixture is carried to the wash tub 302. As can be appreciated, actuation of the flow control device 324 and the washing fluid inlet valve 330 can occur in one example simultaneously. However, in other examples such actuation can occur at different times, such as where the washing fluid inlet valve 330 is opened after the flow control device 324 changes from its second position to its first position.

In one embodiment, the buffer chamber 344 has a fixed volume, which is configured to hold and retain an amount of the additive 318. When the buffer chamber 344 is located subjacent the bulk compartment 312, as illustrated in the present example of FIG. 3, flow of the additive 318 through the upper opening 320 maintains as constant the amount of the additive 318 that is available in the buffer chamber 344. That is, while the size, shape, and other aspects of the buffer chamber 344 can vary in accordance with design parameters for embodiments of the appliance 300, the amount of the additive 318 that is available in the buffer chamber 344 will remain substantially constant during the wash cycle.

Actuation of the flow control device 324 regulates an additive dosage, which in one example is a pre-determined amount of the additive 318 that flows from the buffer chamber 344 to the collection chamber 346. The inventors have found that selective actuation of the flow control device 324, in combination with knowledge of the properties (e.g., viscosity) of the additive 318, is useful to regulate the amount of the additive 318 that is released into the wash tub 302. In one example, relating the viscosity and the time for which the flow control device 324 is in its second position can be used to control the pre-determined amount, thereby defining the size of the additive dosage. This relationship can be implemented as part of the wash cycle such as by specifying the period of time that the flow control device 324 is in the second position. This period can vary such as, for example, to dispense variable amounts of the additive 318 into the collection chamber 346. To illustrate, when dispensing liquids with a viscosity that is higher relative to other liquids, the flow control device 324 is held in its second position longer than when dispensing liquids with a viscosity that is lower relative to other liquids. In one example, each of the bulk compartment 312 and the dispense compartment 314 (including the buffer chamber 344 and the collection chamber 346) hold a volume of the additive 318 that is greater than the volume of the pre-determined amount.

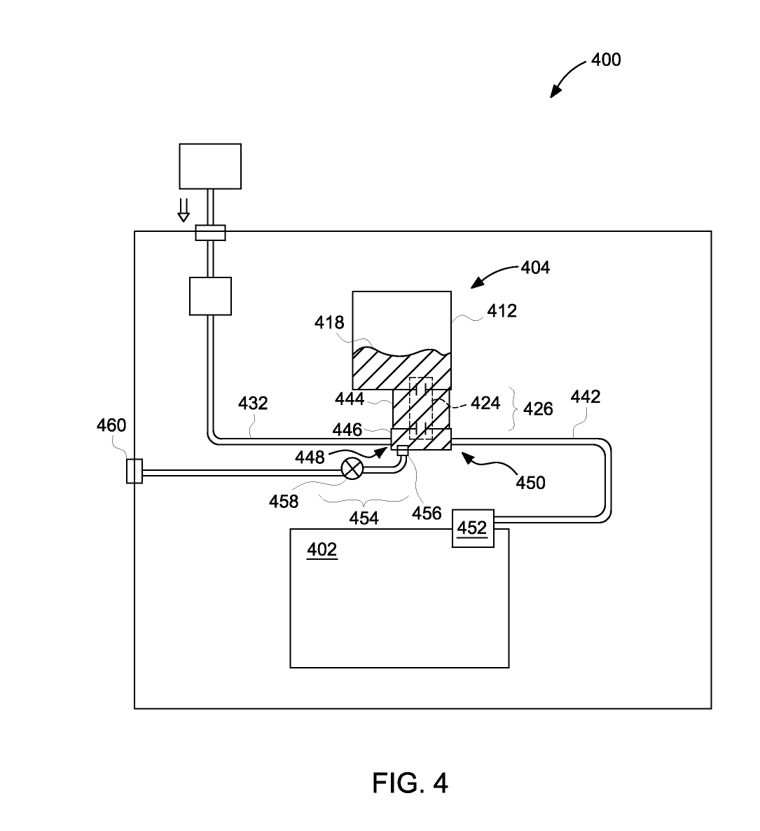

These concepts are also applicable to the configuration illustrated in FIG. 4, in which there is depicted still another exemplary embodiment of an appliance 400. In this configuration, the appliance 400 comprises a wash tub 402 and a dispensing device 404 with a bulk compartment 412 for buffering an additive 318, a flow control device 424, and a metering chamber 426 that is coupled to an inlet conduit 432 and an outlet conduit 442. The metering chamber 426 comprises a buffer chamber 444 and a collection chamber 446, the latter, i.e., the collection chamber 446, having an inlet side 448 and an outlet side 450. In one embodiment, the appliance 400 further includes a fill funnel 452 coupled to the outlet conduit 442, and which is configured in flow communication with the wash tub 402. This combination of components permits the washing fluid (and additive) to flow from the collection chamber 446 to the wash tub 402.

The appliance 400 also comprises a drain system 454, which is used to drain residual fluids (e.g., the washing fluid, the additive 418, and/or the additive/washing fluid mixture) from at least the inlet conduit 432, the outlet conduit 442, and the collection chamber 446. The drain system 454 includes a drain valve 456, which is fluidly coupled to the collection chamber 446, and a pump 458 in communication with the drain valve 456 and to a drain 460. In one embodiment, after dispensing of the additive to the wash tub 402, the flow control device 424 is configured in its first position, wherein the additive 418 is allowed to flow into the buffer chamber 444. The drain valve 456 is activated, which permits fluid communication of the drain system 454 with the collection chamber 446 as well as the other components (e.g., tubing, conduits, etc.) that are coupled to the collection chamber 446. The pump 458 is activated and any residual fluids, including the additive, the washing fluid, and any combinations thereof, are removed and pumped to the drain 460.

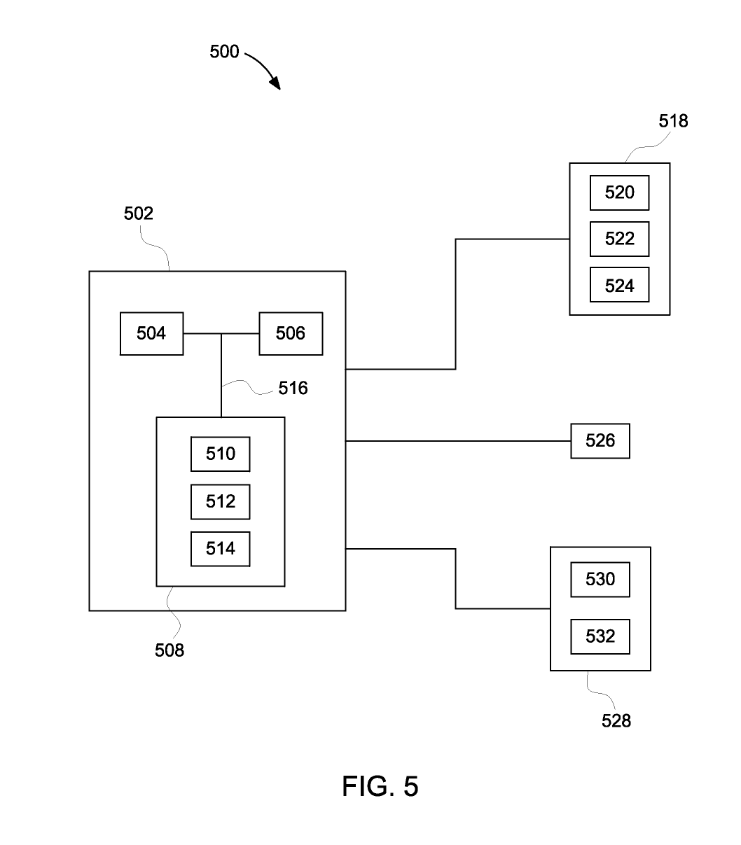

A variety of control configurations and schemes can be used to implement the concepts of the present disclosure. The example of FIG. 5 provides a schematic diagram of one configuration of an exemplary control scheme 500 for use in, e.g., the appliances 100, 200, 300, and 400, and related embodiments (“the appliances”). The control scheme 500 includes a controller 502, which includes a processor 504, a memory 506, and control circuitry 508 configured for general operation of the appliances. The control circuitry 508 comprises a timing circuit 510, a pump control circuit 512, and a valve control circuit 514. All of these components are coupled together and communicate to one another when applicable via one or more busses 516.

The control scheme 500 further includes valves 518 (e.g., valve 520, 522, 524) and a pump 526. In one embodiment, the controller 502 is coupled to a control panel 528 that includes one or more wash cycle controls 530 and an indicator control 532. When implemented in the appliances, the controller 502 effectuates operation of various elements of the appliance such as in response to inputs from the control panel 528. The timing circuit 510, of which various configurations are contemplated, is provided to indicate times and time periods to, e.g., change the configuration of the dispensing device 104, 204, 304 and 404 as between the default condition and the dispensing condition. These time periods may be selected, in connection with or wholly separate from the configuration of the appliance so as to optimize the cleanliness of the objects in the appliance as contemplated herein.

At a high level, the control scheme 500 and its constructive components are configured to communicate amongst themselves and/or with other circuits (and/or devices), which execute high-level logic functions, algorithms, as well as firmware and software instructions. Exemplary circuits of this type include, but are not limited to, discrete elements such as resistors, transistors, diodes, switches, and capacitors, as well as microprocessors and other logic devices such as field programmable gate arrays (“FPGAs”) and application specific integrated circuits (“ASICs”). While all of the discrete elements, circuits, and devices function individually in a manner that is generally understood by those artisans that have ordinary skill in the electrical arts, it is their combination and integration into functional electrical groups and circuits that generally provide for the concepts that are disclosed and described herein.

The electrical circuits of the controller 502 are sometimes implemented in a manner that can physically manifest logical operations, which are useful to facilitate the timing of the wash cycles of the appliance. These electrical circuits can replicate in physical form an algorithm, a comparative analysis, and/or a decisional logic tree, each of which operates to assign an output and/or a value to the output such as to actuate the valves 518 and/or to activate the pump 526.

In one embodiment, the processor 504 is a central processing unit (CPU) such as an ASIC and/or an FPGA. The processor 504 can also include state machine circuitry or other suitable components capable of receiving inputs from, e.g. the control panel 528. The memory 506 includes volatile and non-volatile memory and can be used for storage of software (or firmware) instructions and configuration settings. Each of the timing circuit 510, the pump control circuit 512, and the valve control circuit 514 can be embodied as stand-alone devices such as solid-state devices. These devices can be mounted to substrates such as printed-circuit boards, which can accommodate various components including the processor 504, the memory 506, and other related circuitry to facilitate operation of the controller 502 in connection with its implementation in the fluid dispensing appliances.

However, although FIG. 5 shows the processor 504, the memory 506, the timing circuit 510, the pump control circuit 512, and the valve control circuit 514 as discrete circuitry and combinations of discrete components, this need not be the case. For example, one or more of these components can be contained in a single integrated circuit (IC) or other component. As another example, the processor 504 can include internal program memory such as RAM and/or ROM. Similarly, any one or more of functions of these components can be distributed across additional components (e.g., multiple processors or other components).

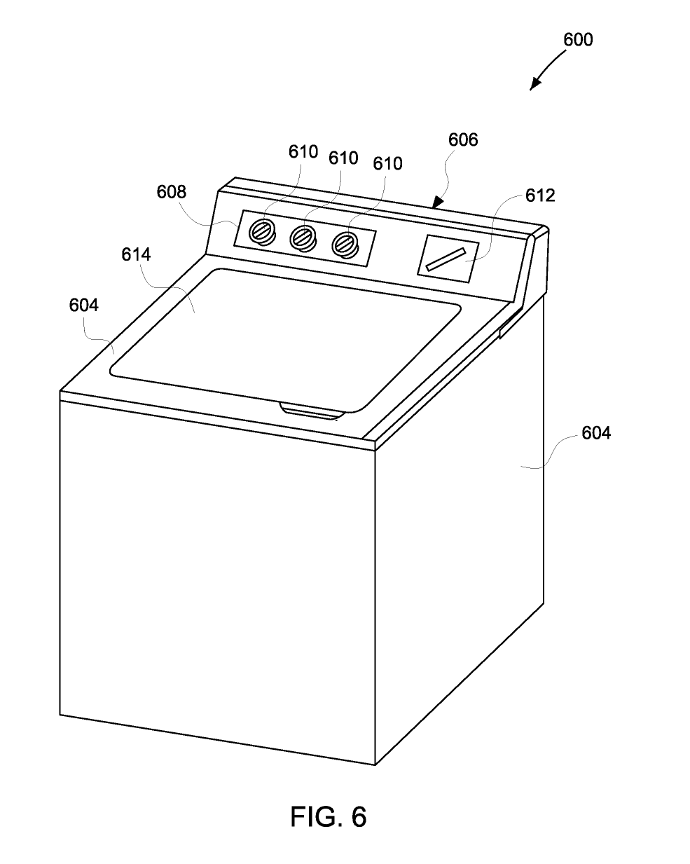

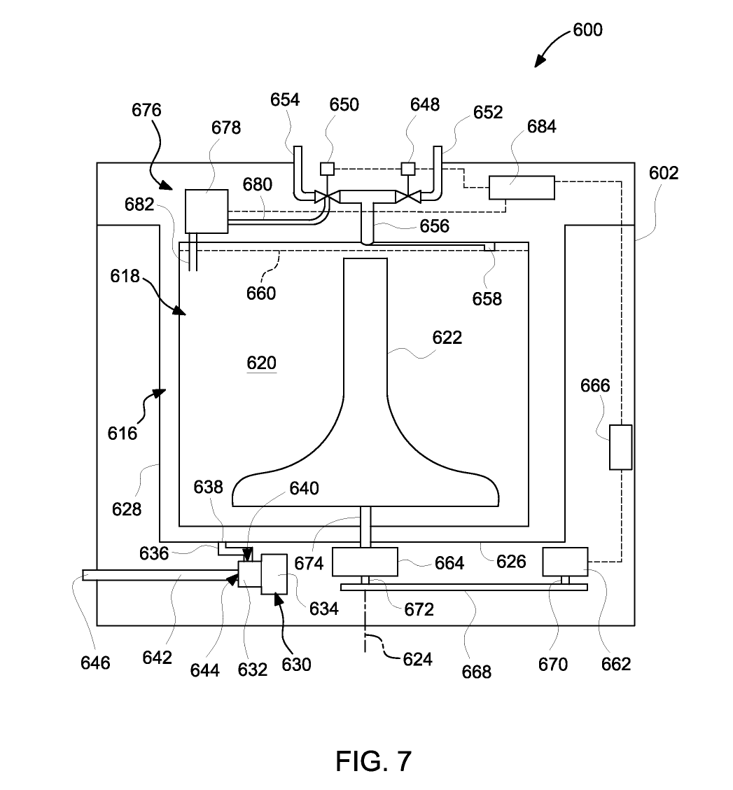

FIGS. 6 and 7 show a washing system or machine generally designated by reference numeral 600. As will be described in further detail below, the washing system or machine 600 can dispense an additive as discussed in connection with FIGS. 1-4 above. In the embodiment illustrated in FIG. 6, the washing machine 600 is depicted as a vertical axis washing machine, however, it is to be understood and appreciated by those skilled in the art that the washing machine 600 could alternatively be a horizontal axis washing machine or some other type of washing machine.

As depicted in FIGS. 6 and 7, the illustrated washing machine 600 includes a cabinet 602 (FIG. 7) and a cover 604. A backsplash 606 extends from the cover 604, and a control panel 608 including a plurality of input selectors 610 is coupled to the backsplash 606. As is known and understood by those skilled in the art, the control panel 608 and the input selectors 610 can collectively form a user interface input for operator selection of machine cycles and features. A display 612 can indicate the selected features, a countdown timer, and/or other items of interest to machine users. A lid 614 is mounted to the cover 604 and is pivotable about a hinge (not shown) between an open position facilitating access to a wash tub 616 (FIG. 7) located within the cabinet 602, and a closed position (as shown) forming an enclosure over the wash tub 616.

With particular reference to FIG. 7, the wash tub 616 is located or positioned within the cabinet 602, and a basket 618 is movably disposed and rotatably mounted within the wash tub 616. As is known and understood by those skilled in the art, the basket 618 can include a plurality of apertures or perforations (not shown) to facilitate fluid communication between an interior 620 of the basket 618 and the wash tub 616. An agitation element 622, such as an agitator, impeller, auger, oscillatory basket mechanism, etc., or a combination of the foregoing, is disposed in the basket 618 to impart motion to the articles or wash load within the basket 618. In particular, in the illustrated embodiment, the agitation element 622 is a vane agitator rotatably positioned within the basket 618 on vertical axis 624 for imparting motion to articles and liquid received within the basket 618.

The wash tub 616 includes a bottom wall 626 and a side wall 628, the basket 618 being rotatably mounted or supported within the wash tub 616 in spaced apart relation from the bottom wall 626 and the side wall 628. A pump assembly 630 is located beneath the wash tub 616 and the basket 618 for gravity assisted flow when draining the wash tub 616. The pump assembly 630 includes a pump 632, a motor 634, and in an exemplary embodiment a motor fan (not shown). A pump inlet hose 636 extends from a wash tub outlet 638 in bottom wall 626 to a pump inlet 640, and a pump outlet hose 642 extends from pump outlet 644 to a drain outlet 646 and ultimately to a building plumbing system discharge line (not shown) in flow communication with the drain outlet 646. In operation, pump assembly 630 can be selectively activated to remove liquid from the basket 618 and the wash tub 616 through drain outlet 646 during appropriate points in washing cycles as washing machine 600 is used.

A hot liquid valve 648 and a cold liquid valve 650 deliver fluid, such as water, to the basket 618 and the wash tub 616 through a respective hot liquid hose 652 and a cold liquid hose 654. Liquid valves 648, 650 and liquid hoses 652, 654 together form a liquid supply connection for the washing machine 600 and, when connected to a building plumbing system (not shown), provide a water supply for use in the washing machine 600. Liquid valves 648, 650 and liquid hoses 652, 654 are connected to a basket inlet tube 656, and fluid can be dispersed from the basket inlet tube 656 through a nozzle assembly 658 having a number of openings therein to direct washing liquid into basket 618 at a given trajectory and velocity.

In an alternate embodiment, a spray fill conduit 660 (shown in phantom in FIG. 7) can be employed in lieu of the nozzle assembly 658. Along the length of the spray fill conduit 660 can be a plurality of openings (not shown) arranged in a predetermined pattern to direct incoming streams of water in a downward tangential manner towards a wash load in the basket 618. The openings in the spray fill conduit 660 can be located a predetermined distance apart from one another to produce an overlapping coverage of liquid streams into the basket 618. The wash load in the basket 618 may therefore be uniformly wetted even when the basket is maintained in a stationary position, of course, any other type of nozzle or spray fill conduit could be used in the washing machine 600.

In an exemplary embodiment, the basket 618 and the agitation element 622 are driven by a motor 662 through a transmission and clutch system 664. The motor 662 is driven by an inverter 666. A transmission belt 668 is coupled to respective pulleys of a motor output shaft 670 and a transmission input shaft 672. Thus, as motor output shaft 670 is rotated, transmission input shaft 672 is also rotated. Clutch system 664 facilitates driving engagement of the basket 618 and the agitation element 622 through shaft 674 for rotatable movement within the wash tub 616, and clutch system 664 facilitates relative rotation of the basket 618 and the agitation element 622 for selected portions of wash cycles. Motor 662, transmission and clutch system 664 and transmission belt 668 can collectively be referred to as a machine drive system, the drive system being drivingly connected to the basket 618 and the agitation element 622 for rotating the basket 618 and/or the agitation element 622.

In the illustrated embodiment, the washing machine 600 further includes a dispenser 676 mounted in the cabinet 602 for dispensing an additive, such as a detergent, bleach, fabric softener, etc., or any combination of the foregoing, into the wash tub 616 and/or basket 618. The dispenser 676 can be provided as part of a bulk dispensing system integrated into the washing machine 600 or any other type of automatic or semi-automatic filling and/or dispensing system. In one embodiment, the dispenser 676 can include a tank 678 for receiving and holding the laundry additive, the tank 678 being configured as discussed in connection with the tanks 108, 208, 308, and 408 of FIGS. 1-4 and related embodiments. It is also contemplated that the washing machine 600 and related embodiments can employ a plurality of the tank 678 such as could be used to hold different additives. Likewise the tanks of the plurality of the tank 678 could be configured so as to utilize a single metering chamber, e.g., a metering chamber 226, 326, 426, wherein the additive from each of the tanks 678 is disposed in at different times and flushed from the single metering chamber to the wash tub 616. In still other configurations of the washing machine 600, two or more of the tanks 678 could share or otherwise be coupled to the same metering chamber so that the number of metering chambers is less than the number tanks 678.

Referring back to FIG. 7, there is also shown that an inlet conduit 680 is coupled to the tank 678 and to one or more of the hot liquid valve 648 and the cold liquid valve 650 so as to facilitate flushing the laundry additive out of the tank 678 and into the wash tub 616. An outlet conduit/nozzle 682 is provided for directing any amount of the laundry additive that is released into the wash tub 616 and/or basket 618. In one embodiment, the tank 678 is mounted on an inside wall of the cabinet 602 at an upper portion thereof and can be filled manually when the lid 614 is opened.

Operation of the washing machine 600 can be controlled by a controller 684 (e.g., the controller 502 of FIG. 5). For example, the controller 684 can be operatively connected to the user interface input located on the backsplash 606 for user manipulation to select washing machine cycles and features. In response to user manipulation of the user interface input, the controller 684 operates the various components of the washing machine 600 to execute selective machine cycles and features. The controller 684 can also be operatively coupled to the motor 662, the nozzle assembly 658 (or alternatively the spray fill conduit 660), and/or the dispenser 676.

It is further contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

This written description uses examples to disclose embodiments of the invention, including the best mode, and also to enable any person skilled in the art to practice the invention, including making and using any devices or systems and performing any incorporated methods. The patentable scope of the invention is defied by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A dispensing device for dispensing an additive in an appliance, said dispensing device comprising:
a first compartment;
a second compartment in gravity-flow communication with the first compartment; and
a flow control device through which can flow the additive from the first compartment to the second compartment,
wherein the flow control device is configured to regulate a pre-determined amount of the additive that flows by gravity out of the second compartment.

2. A dispensing device according to claim 1, wherein the second compartment is configured to permit the additive to mix with a washing fluid.

3. A dispensing device according to claim 1, wherein the flow control device is incorporated into the second compartment.

4. A dispensing device according to claim 1, wherein the flow control device has a position in which the additive does not flow from the first compartment to the second compartment, and wherein the pre-determined amount is related to a period of time for which the flow control device is in the position.

5. A dispensing device according to claim 1, wherein the second compartment is subjacent the first compartment.

6. A dispensing device according to claim 1, wherein each of the first compartment and the second compartment is configured to hold a volume of the additive that is greater than the volume of the pre-determined amount.

7. A dispensing device according to claim 6, wherein the volume of the first compartment is greater than the volume of the second compartment.

8. A dispensing device according to claim 1, further comprising a third compartment in gravity-flow communication with the second compartment, wherein the pre-determined amount is dispensed into the third compartment, and wherein the third compartment is configured to permit the additive to mix with a washing fluid.

9. A dispensing device according to claim 8, wherein the first compartment, the second compartment, and the third compartment are incorporated into a tank.

10. A dispensing device according to claim 1, wherein the flow control device is configured for additives that are liquids.

11. A dispensing device according to claim 1, wherein the flow control device is configured for additives that are granular.

12. An appliance, comprising:
a wash tub;
a dispensing device in fluid communication with the wash tub; and
a fluid inlet coupled to the dispensing device,
wherein the dispensing device has a default condition in which flows an additive by gravity from a first location to a second location, and
wherein the dispensing device is configured to regulate a pre-determined amount of the additive that is dispensed by gravity from the second location.

13. An appliance according to claim 12, further comprising a controller, wherein the controller is configured to change the dispensing device between the default condition and a dispensing condition in which the additive is exposed to a washing fluid from the fluid inlet.

14. An appliance according to claim 13, wherein the additive does not flow from the first location to the second location in the dispensing condition.

15. An appliance according to claim 13, wherein the controller is configured to relate a period of time that the dispensing device is in the dispensing condition with a viscosity of the additive to regulate the pre-determined amount.

16. An appliance according to claim 13, further comprising a flow control device disposed in the dispensing device, wherein the controller is configured to actuate the flow control device to implement each of the dispensing condition and the default condition.

17. An appliance according to claim 12, wherein the dispensing device comprises a tank with a compartment in fluid communication with the fluid inlet and at which the pre-determined amount of the additive is mixed with a washing fluid.

18. An appliance according to claim 12, wherein the amount of the additive in the first location is greater than the amount of the additive at the second location.
